(19) United States
(12) Patent Application Publication
(10) Pub. No.: US 2006/0005677 A1
(43) Pub. Date: Jan. 12, 2006

(54) Fence assembly for miter saws

(76) Inventors: Torrey R. Lambert, Baltimore, MD (US); Robert S. Gehret, Hampstead, MD (US); Mark D. Miller JR., Airville, PA (US)

Correspondence Address: THE BLACK & DECKER CORPORATION, 701 EAST JOPPA ROAD, TW199, TOWSON, MD, 21286, US

(21) Appl. No.: 11/175,735

(22) Filed: Jul. 6, 2005

Related U.S. Application Data
(60) Provisional application No. 60/586,123, filed on Jul. 7, 2004.

(51) Int. Cl. B23D 19/00; B26D 1/14

(52) U.S. Cl. 83/471.3

(57) ABSTRACT

A power tool has a base assembly, a table supported by the base assembly, and a saw assembly attached to the table. In addition, a fixed fence is attached to the table. A sliding carriage is slidably connected to the fixed fence. A fence portion is pivotally attached to the sliding carriage. The fence portion has a surface. The fence portion is movable between a first position where the surface is substantially perpendicular to the table, and a second position where the fence portion is moved downwardly towards the table.

### REFERENCE TO CROSS-RELATED APPLICATION

The present application derives priority under 35 USC § 119(e) from U.S. Patent Application No. 60/586,123, filed Jul. 7, 2004.

### FIELD OF THE INVENTION

This invention relates generally to a fence assembly for miter saws and more specifically to a fence assembly for a combination table/miter saw.

### BACKGROUND OF THE INVENTION

It is well known in the miter saw field to provide a sliding fence assembly that has a sliding portion that is moved when the saw assembly is beveled, so that the sliding portion does not contact the saw assembly. Such sliding fence assembly cannot be used in a combination table/miter saw when it is in the table saw mode, as the user is not able to access the sliding portion and/or move the sliding portion to a non-contacting position. It is an object of the invention to provide an enhanced fence assembly for combination table/miter saws, and miter saws.

### SUMMARY OF THE INVENTION

In accordance with the present invention, an improved support assembly is employed. The power tool has a base assembly, a table supported by the base assembly, a saw assembly attached to the table, a fixed fence attached to the table, a sliding carriage slidably connected to the fixed fence, and a fence portion pivotally attached to the sliding carriage, the fence portion having a surface, and being movable between a first position where the surface is substantially perpendicular to the table, and a second position where the fence portion is moved downwardly towards the table.

Additional features and benefits of the present invention are described, and will be apparent from, the accompanying drawings and the detailed description below.

### BRIEF DESCRIPTION OF THE DRAWINGS

The accompanying drawings illustrate preferred embodiments of the invention according to the practical application of the principles thereof, and in which:

FIG. 1 illustrates a combination table/miter saw according to the invention, whereas FIGS. 1A-1B are side views of the combination table/miter saw in the miter saw and table saw modes, respectively; and

FIG. 2 illustrates the saw assembly with a fence assembly according to the invention, where FIGS. 2A-2B are front and rear perspective views of such fence assembly in an upper position, respectively, and FIG. 2C is a top plan view of such fence assembly in a lower position.

### DETAILED DESCRIPTION

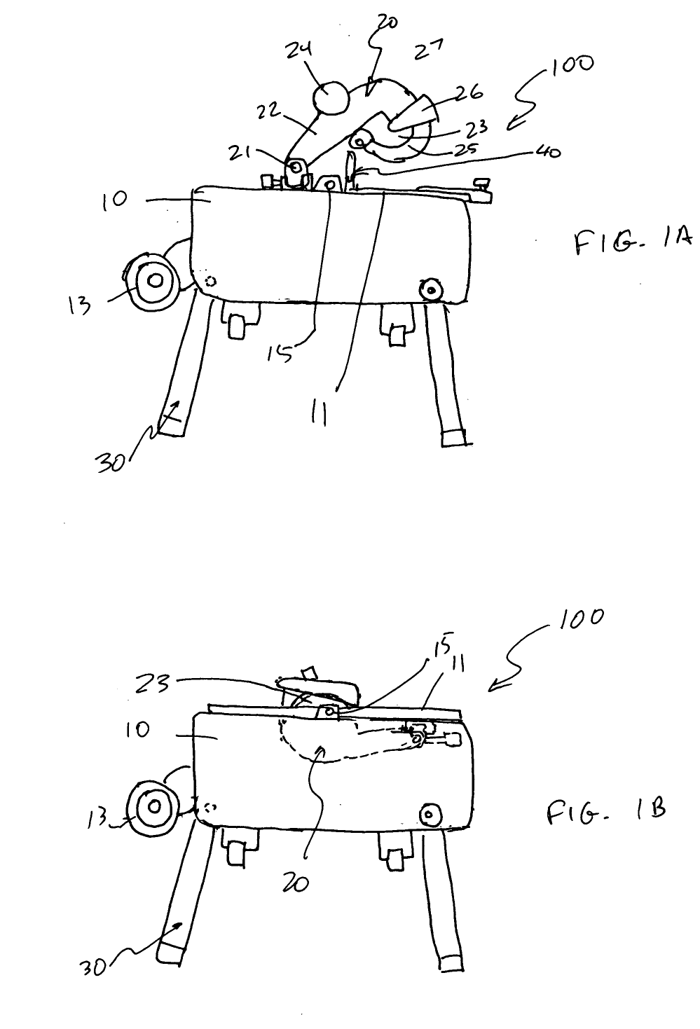

The invention is now described with reference to the accompanying figures, wherein like numerals designate like parts. Referring to FIG. 1, a combination table/miter saw 100 may include a base assembly 10, a table 11 supported by base assembly 10, and a saw assembly 20 supported by the table 11. Saw assembly 20 may include a trunnion 21 disposed on the table 11, a pivotable arm 22 pivotably attached to trunnion 21, a motor 24 supported by the arm 22 and driving a blade 23. Arm 22 also supports upper blade guard 27, which covers an upper part of blade 23. Lower blade guard 25 is pivotally attached to upper blade guard 27. An auxiliary blade guard 26 may be pivotably connected to lower blade guard 25.

Preferably, table 11 is pivotally attached to base assembly 10 via joint 15 so that, when the table 11 is in the orientation of FIG. 1A, the saw assembly 20 can act as a miter saw, i.e., saw assembly 20 can be pivoted downwardly towards table 11 to cut a workpiece placed on table 11.

On the other hand, when table 11 is rotated via joint 15 to the orientation of FIG. 1B, the saw 100 acts as a table saw, i.e., saw assembly 20 will be supported by and disposed underneath the table 11. In such orientation, blade 23 extends through the table 11, so that a user can dispose a workpiece on table 11 and push it towards blade 23 for cutting.

Persons skilled in the art will recognize that the invention described below can be applicable to non-combined miter saws.

Preferably, base assembly 10 has at least one wheel 13 thereon.

Base assembly 10 may also support four leg assemblies 30. Preferably leg assemblies 30 are pivotally attached to base assembly 10.

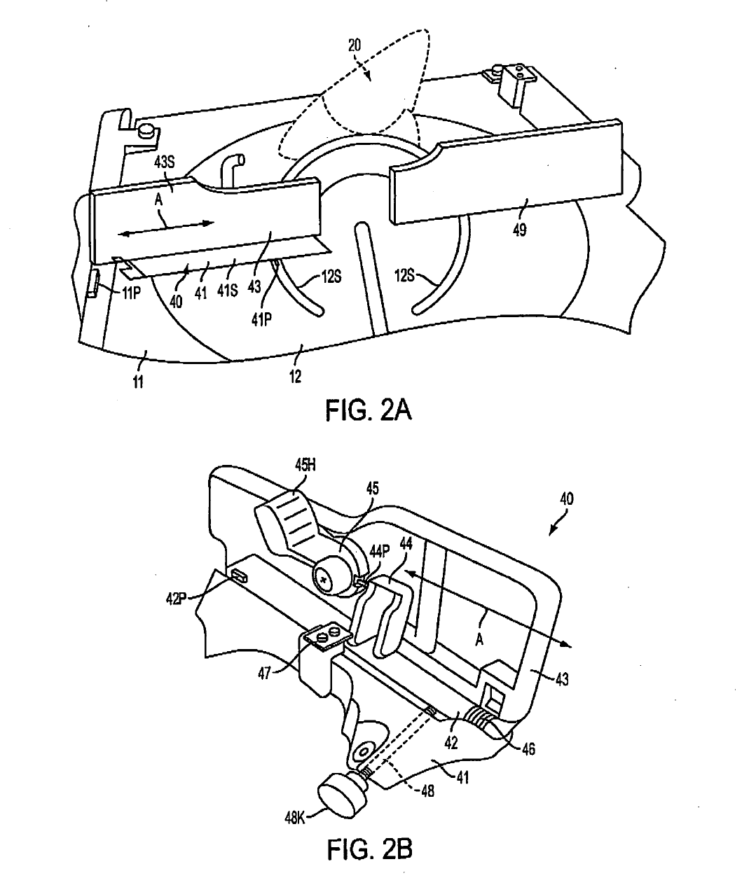

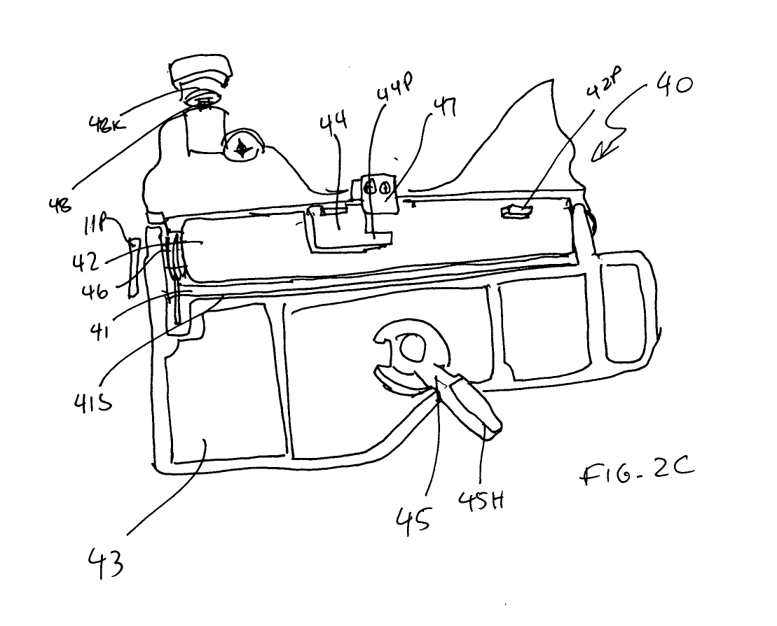

Referring to FIGS. 1-2, saw 100 may have a fence assembly 40 disposed on the same side of table 11 which supports saw assembly 20. Fence assembly 40 may include a fixed portion 41 that is fixedly mounted unto table 11.

Persons skilled in the art will recognize that table 11 may have a rotatable table 12 disposed thereon and that saw assembly 20 is preferably mounted to rotatable table 12. Such arrangement will allow changing the miter angle of saw assembly 20 relative to fence assembly 40. It is preferable not to fixedly mount fixed portion 41 unto rotatable table 12. However, fixed portion 41 may have a downward protrusion 41P which slides along an arcuate slot 12S provided on rotatable table 12. In this manner, rotatable table 12 may support fence assembly 40 without restricting the rotational movement of rotatable table 12.

Fixed portion may have a substantially U-shaped cross-section defining a channel therein. A slide carriage 42 may be disposed on in said channel. A fence portion 43 may be rotatably attached to the slide carriage 42.

Fence portion 43 has a surface 43S which supports a workpiece thereon. Persons skilled in the art will recognize that fixed portion 41 may have a surface 41S which supports a workpiece thereon. Surfaces 41S, 43S are preferably substantially coplanar.

A screw 48 may extend through fixed portion 41 and contact slide carriage 42. Screw 48 may be rotated via knob 48K.

With such arrangement, when saw assembly 20 is beveled in miter saw mode, slide carriage 42 and fence portion 43 may be moved sideways along direction A out of the way by sliding them relative to fixed portion 41. When the desired position of slide carriage 42 and/or fence portion 43 is reached, the user can lock slide carriage 42 and/or fence portion 43 by rotating knob 48K. Screw 48 will then push slide carriage 42 into locking contact with fixed portion 41. Persons skilled in the art will recognize that slide carriage 42 and/or fence portion 43, when moved sideways, can be used to prevent rotation of table 11, as slide carriage 42 and/or fence portion 43 will contact base assembly 10.

Preferably fixed portion 41 supports a hold-down plate 47 which overlaps slide carriage 42. Plate 47 preferably prevents the removal of slide carriage 47 and/or fence portion 43 by lifting. Slide carriage 42 may have a protrusion 42P which contacts plate 47 to limit the sliding range of slide carriage 42 and/or fence portion 43.

Plate 47 may be disposed so that it contacts slide carriage 42, to minimize the rotation of slide carriage 42 (and fence portion 43) during operation, thus maintaining the accuracy of fence assembly 40.

As mentioned above, fence portion 43 may be rotatably connected to slide carriage 42. Slide carriage 42 may support a post 44. Fence portion 43 may have a catch 45 rotatably connected to fence portion 43. Catch 45 may be moved between a first position engaging a protrusion 44P of post 44 and a second position not engaging protrusion 44P. A spring (not shown) may bias catch 45 towards the first position. A user can rotate catch 45 to the second position by moving a handle 45H connected to catch 45.

Persons skilled in the art will recognize that, when catch 45 engages protrusion 44P, fence portion 43 and sliding carriage 42 move jointly, and surface 43S is substantially perpendicular to table 11. When catch 45 is not engaged to protrusion 44P, fence portion 43 can be rotated downwardly and disposed on table 11. Preferably, a spring 46 biases fence portion 43 to such downward position so that, when the user moves catch 45 to the second position, fence portion 43 automatically moves to the downward position.

Surface 43S may be substantially parallel to table 11 or may contact table 11 in the downward position. Preferably fence portion 43 is flush against table 11 when in the downward position, so that a user cannot use saw 100 in miter saw mode when fence portion 43 is in the downward position.

Such arrangement is advantageous as, when the fence portion 43 is in the downward position, the saw assembly 20 cannot contact fence portion 43 at any bevel angle. This obviates the need to move fence portion 43 sideways when beveling the saw assembly 20, which is difficult to do when using saw 100 in table saw mode.

Table 11 may have a protrusion 11P, which prevents fence portion 43 from lying flush against table 11 if slide carriage 42 and/or fence portion 43 had been moved sideways prior to releasing catch 45. Such protrusion 11P also prevents slide carriage 42 and/or fence portion 43 from moving sideways after catch 45 has been released and fence portion 43 lies flush against table 11. This prevents fence portion 43 from contacting base 10 and/or interfering with the pivoting operation of table 11 where saw 100 is changed from miter saw mode to table saw mode. Persons skilled in the art will recognize that such protrusion 11P may also be provided on base assembly 10.

Saw 100 may also have a fixed fence 49 on the other side of saw assembly 20. Persons skilled in the art will recognize that if the saw assembly 20 is double-beveling, i.e., bevels both rightwardly and leftwardly, it would be advantageous to replace fixed fence 49 with a sliding fence assembly as discussed above.

Persons skilled in the art may recognize other additions or alternatives to the means disclosed herein. However, all these additions and/or alterations are considered to be equivalents of the present invention.

We claim:

1. A power tool comprising:
a base assembly;
a first table supported by the base assembly;
a saw assembly attached to the first table;
a fixed fence attached to the first table;
a sliding carriage slidably connected to the fixed fence; and
a fence portion pivotally attached to the sliding carriage, the fence portion having a surface, and being movable between a first position where the surface is substantially perpendicular to the first table, and a second position where the fence portion is moved downwardly towards the first table.

2. The power tool of claim 1, wherein the fence portion is connectable to the fixed fence.

3. The power tool of claim 1, wherein the fixed fence comprises a protrusion.

4. The power tool of claim 3, wherein the fence portion is engageable to the protrusion.

5. The power tool of claim 3, wherein the fence portion supports a catch which is movable between a first position engaging the protrusion, and a second position not engaging the protrusion.

6. The power tool of claim 5, wherein the catch is connected to a handle for moving the catch between the first and second positions.

7. The power tool of claim 1, wherein at least one of the sliding carriage and the fence portion has a spring for biasing the fence portion towards the second position.

8. The power tool of claim 1, wherein the fixed fence has a plate contacting the sliding carriage.

9. The power tool of claim 1, further comprising a second table pivotably attached to the first table, the second table being rotatable about a substantially vertical axis.

10. The power tool of claim 9, wherein the fixed fence has at least one downwardly-extending protrusion engaging the second table.

11. The power tool of claim 9, wherein the fixed fence has at least one downwardly-extending protrusion engaging a slot on the second table.

12. The power tool of claim 1, wherein the first table is pivotally attached to the base assembly.

13. The power tool of claim 12, wherein the first table is movable between a first position where the saw assembly is disposed above the first table, and a second position where the saw assembly is disposed below the first table.

14. The power tool of claim 12, wherein the first table rotates about a substantially horizontal axis.

15. The power tool of claim 1, further comprising a screw extending through and threadingly engaged to the fixed fence to move the sliding carriage against the fixed fence.

16. The power tool of claim 1, wherein the sliding carriage has a protrusion contacting the fixed fence for limiting movement range of the sliding carriage.

17. The power tool of claim 1, wherein at least one of the first table and the base assembly has a protrusion limiting movement range of the sliding carriage when the fence portion is in the second position.
